(19) United States
(12) Patent Application Publication
(10) Pub. No.: US 2025/0393072 A1
(43) Pub. Date: Dec. 25, 2025

(54) MULTILINK DEVICE AND METHOD OF OPERATING THE SAME FOR PROVIDING RELIABLE AND LOW-LATENCY DATA TRANSMISSION

(71) Applicant: Realtek Semiconductor Corp., HsinChu (TW)

(72) Inventors: Wei-Kang Fan, HsinChu (TW); Sheng-Wei Fan, HsinChu (TW)

(73) Assignee: Realtek Semiconductor Corp., HsinChu (TW)

(21) Appl. No.: 19/193,948

(22) Filed: Apr. 29, 2025

(30) Foreign Application Priority Data
Jun. 25, 2024 (TW) 113123596

(51) Int. Cl. H04W 74/0816; H04W 48/02; H04W 88/12

(52) U.S. Cl. CPC H04W 74/0816; H04W 48/02; H04W 88/12

(57) ABSTRACT

A multi-link device includes a multi-link controller, and first and second MAC controllers. The first MAC controller includes a first link queue to buffer a first set of packets from the common queue. The second MAC controller includes a second link queue to buffer a second set of packets from the common queue. In response to the first MAC controller being granted a first transmission opportunity of a first link, and the second MAC controller not being granted a second transmission opportunity of a second link, the multi-link controller determines whether to enable a link redirect mode according to an aspect of the second set of packets. In response to the link redirect mode being enabled, the first MAC controller receives a packet in the second set of packets from the second link queue, and transmits the packet in the second set of packets via the first link.

### BACKGROUND OF THE INVENTION

### 1. Field of the Invention

The invention relates to a Wi-Fi network, and in particular, to a Wi-Fi network device and an operating method thereof for transmitting time-sensitive data in a stable, reliable, and low-latency manner.

### 2. Description of the Prior Art

IEEE 802.11be standard specifies communication protocols of wireless access technologies for the new generation of Wi-Fi 7, supporting multi-link operations (MLO) and a block acknowledgment (BA) mechanism. MLO is used to aggregate multiple channels over different frequency bands, so as to ensure seamless data transmission regardless of signal interference or network congestion in certain frequency bands, enhancing the data rate and reliability of the network, and being significant in video streaming and gaming applications requiring stable, continuous and real-time transmission quality. The BA mechanism uses a BA frame to acknowledge reception of a set of packets having been successfully received. MLO may be used to achieve high data rates, high throughputs, and low latency.

During a multi-link operation, the multi-link device pre-assigns packets for each link to speed up data transmission and improve transmission efficiency. However, the channel conditions change over time. If a channel is affected by significant noise and long-term interference after packet assignment, the assigned packets may not be transmitted smoothly. In addition, in order to meet the BA requirement, the congested packets would further prevent the multi-link device from assigning more packets to channel in the good transmission condition, leading to decreased transmission efficiency. The frequent noise and interference across various links can lead to frequent packet redirect, which consume substantial processing resources and data bandwidth, significantly reducing overall transmission efficiency.

### SUMMARY OF THE INVENTION

According to an embodiment of the invention, a multi-link device includes a multi-link controller, a first MAC controller and a second MAC controller. The first MAC controller is coupled to the multi-link controller and is used to perform a function of a first link. The first MAC controller includes a first link queue used to receive a first set of packets from the common queue and buffer the first set of packets. The second MAC controller is coupled to the multi-link controller and is used to perform a function of a second link. The second MAC controller includes a second link queue used to receive a second set of packets from the common queue and buffer the second set of packets. In response to the first MAC controller being granted a first transmission opportunity of the first link, and the second MAC controller not being granted a second transmission opportunity of the second link, the multi-link controller determines whether to enable a link redirect mode according to an aspect of the second set of packets. In response to the link redirect mode being enabled, the first MAC controller receives a packet in the second set of packets from the second link queue, and transmits the packet in the second set of packets via the first link.

According to another embodiment of the invention, a multi-link device includes a multi-link controller, a first MAC controller and a second MAC controller, the multi-link controller including a common queue, the first MAC controller being coupled to the multi-link controller to perform a function of a first link and including a first link queue, the second MAC controller being coupled to the multi-link controller to perform a function of a second link and including a second link queue. A method operating the multi-link device includes a first link queue receiving a first set of packets from the common queue and buffer the first set of packets, a second link queue receiving a second set of packets from the common queue and buffer the second set of packets, in response to the first MAC controller being granted a first transmission opportunity of the first link, and the second MAC controller not being granted a second transmission opportunity of the second link, the multi-link controller determining whether to enable a link redirect mode according to an aspect of the second set of packets, and in response to the link redirect mode being enabled, the first MAC controller receiving a packet in the second set of packets from the second link queue, and transmitting the packet in the second set of packets via the first link.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a multi-link device according to an embodiment of the invention.

FIG. 2 is a schematic diagram of a method of operating the multi-link device in FIG. 1.

FIG. 3 is a flowchart of a method of operating the multi-link device in FIG. 1.

FIG. 4 is a block diagram of a multi-link device according to another embodiment of the invention.

FIG. 5 is a flowchart of the link redirect step S310 in FIG. 3.

### DETAILED DESCRIPTION

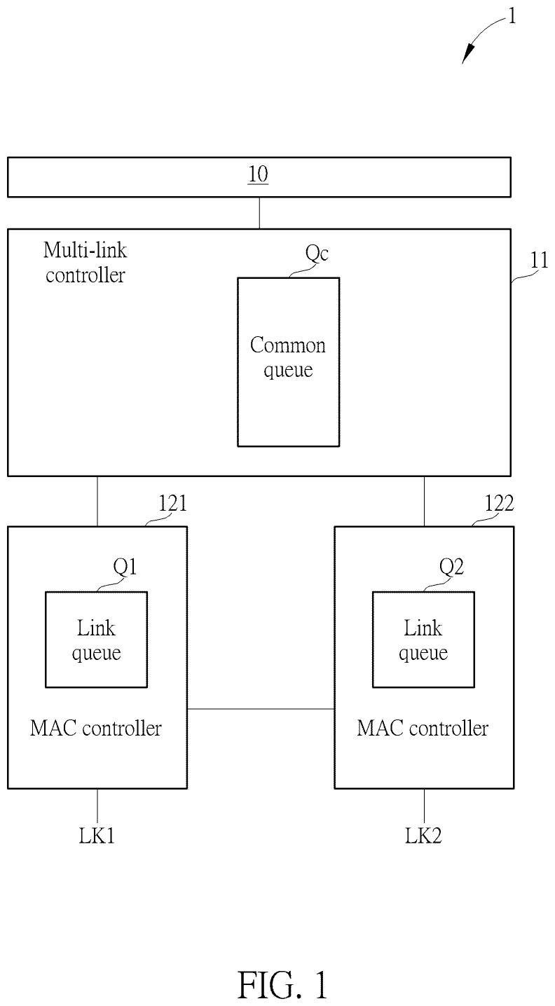

FIG. 1 is a block diagram of a multi-link device (MLD) 1 according to an embodiment of the present invention. The multi-link device 1 may be an access point multi-link device (AP MLD) or a non-access point multi-link device (non-AP MLD), supporting multi-link operations (MLO) and a block acknowledgment (BA) mechanism, and is compatible with the IEEE 802.11 standard such as IEEE 802.11be standard.

The link LK1 and the link LK2 may be established in the same or different frequency bands between the multi-link device 1 and another multi-link device. For example, the link LK1 may operate in the 2.4 GHz frequency band, and the link LK2 may operate in the 5 GHz frequency band. The multi-link device 1 may simultaneously exchange data packets with another multi-link device via the link LK1 and the link LK2, respectively.

The multi-link device 1 may include a multi-link controller 11, a media access control (MAC) controller 121, and a MAC controller 122. The multi-link controller 11 may receive packets from the upper layer 10 and distribute the packets to the MAC controllers 121 and 122. Therefore, the multi-link controller 11 is also referred to as a multi-link engine or an upper MAC controller, and the MAC controllers 121 and 122 are also referred to as lower MAC controllers. The upper layer 10 is a protocol layer above the MAC layer. For example, the upper layer 10 may be but is not limited to the network layer. The packets may be the media access control (MAC) service data units (MSDU). The MAC controller 121 may be coupled to the multi-link controller 11, and may perform functions of the link LK1, including transmitting packets via the link LK1. The MAC controller 122 may be coupled to the multi-link controller 11, and may perform functions of the link LK2, including transmitting packets via the link LK2. The multi-link controller 11, the MAC controller 121 and the MAC controller 122 may be implemented by hardware and/or firmware. The multi-link controller 11 may control the transmission path of the packets and pre-distribute the packets to the MAC controllers 121 and/or 122. The MAC controllers 121 and 122 may perform enhanced distributed channel access (EDCA) functions, and adopt the carrier sense multiple access/collision avoidance (CSMA/CA) mechanism, thereby contending for transmission opportunities (TXOP) on the links LK1 and LK2 through random backoff. In order to avoid collisions, prior to transmitting the packets, the MAC controllers 121 and 122 may determine the availabilities of the links LK1 and LK2 during an arbitration inter-frame space (AIFS) period. If data is being transmitted in the link LK1 or LK2, the MAC controller 121 and/or 122 may determine that the transmission medium is busy. If the link LK1 or LK2 is idle, the MAC controller 121 or 122 may wait for a randomly selected backoff time and may transmit packets after the transmission opportunity of the link LK1 or LK2 is granted. If the MAC controller 121 is granted the first transmission opportunity of the link LK1, the MAC controller 121 may transmit the packets to the other multi-link device via the first transmitter (not shown) and the link LK1 during the first transmission opportunity. Similarly, if the MAC controller 122 is granted the second transmission opportunity of the link LK2, the MAC controller 122 may transmit the packets to the other multi-link device via the second transmitter (not shown) and the link LK2 during the second transmission opportunity. Each transmission opportunity may have a transmission time limit (TXOP limit), and the transmission time limit is related to the access category (AC) of the packets. For example, the access categories may be background (BK), best effort (BE), video (VI), and voice (VO). The transmission time limits of the background and best effort categories may be 0s, the transmission time limit of the video category may be 3.008 ms, and the transmission time limit of the voice category may be 1.504 ms.

The MLD 1 may adopt the BA mechanism, and establish a BA agreement for the multi-link operation (MLO) over the links LK1 and LK2. The BA agreement includes a BA window size to maintain the BA window during the BA session. The BA window size may be 64, 128, 256, 1024 or other quantities of media access control (MAC) packets. Each packet may have a sequence number (SN) and may be indexed according to the sequence number thereof. For example, the upper-layer software on the MLD 1 may divide a single file into 100 MAC packets, and attach sequence numbers from 1 to 100 to the 100 MAC packets, respectively. In some embodiments, the upper-layer software may transmit the packets having the sequence numbers attached to the multi-link controller 11. In other embodiments, the upper-layer software may only transmit the packets to the multi-link controller 11. When transmitting the packets, other hardware circuits of the multi-link device 1 may use an internal counter to generate and attach sequential sequence numbers to the packets, and then transmit the packets. If the BA window size is 64, after the multi-link device 1 transmits 64 packets (sequence numbers 1 to 64) through links LK1 and/or LK2, the receiving multi-link device may send back a BA frame to acknowledge the successful receipt of the packets. Since there is no need for performing individual acknowledgments for individual packets, and the packets in the BA window may share a physical layer protocol header (PHY header), the implementation of the BA mechanism will reduce the overhead and increase the throughput of the multi-link device 1.

The multi-link controller 11 may include a common queue Qc, the MAC controller 121 may include a link queue Q1, and the MAC controller 122 may include a link queue Q2. The MAC controller 121 may be the primary device of accessing the link queue Q1, and the MAC controller 122 may be the secondary device of accessing the link queue Q1. That is, when the MAC controller 121 cannot successfully transmit the packets in the link queue Q1, the MAC controller 122 may access the link queue Q1 to resume packet transmission. Similarly, the MAC controller 122 may be the primary device of accessing the link queue Q2, and the MAC controller 121 may be the secondary device of accessing the link queue Q2. That is, when the MAC controller 122 cannot successfully transmit the packets in the link queue Q2, the MAC controller 121 may access the link queue Q2 to resume packet transmission. In some embodiments, the common queue Qc, the link queue Q1 and/or the link queue Q2 may further be merged into a single queue. In some embodiments, the common queue Qc, the link queue Q1 and/or the link queue Q2 may further be disposed at other locations in the multi-link device 1. The multi-link controller 11 may receive packets from the upper layer 10, buffer the packets in the common queue Qc, and allocate the packets to the ink queues Q1 or Q2 according to system information and/or environmental parameters. If the packets are allocated to the link queue Q1 or Q2 before the MAC controller 121 or 122 starts the backoff time thereof, the circuit requirement of data transmission of the multi-link device 1 may be reduced. The system information may include a data status of the link queue Q1, a data status of the link queue Q2, a power saving status, the BA window size, and other information. The environmental parameters may include a channel condition, a transmission speed, a transmission bandwidth, a rate of successful transmissions, and other parameters. In order to comply with the requirements of the BA mechanism, the multi-link controller 11 may only allocate packets within the BA window to the link queues Q1 and Q2. Consider a case for a BA window size of 64, the common queue Qc holds packets of sequence numbers 100 to 200, the link queue Q1 contains packets of sequence number 1 to 10, and the link queue Q2 is empty. Since the packet of the sequence number 1 has not been transmitted yet, the BA window's maximum sequence number remains at 64. This creates a problem: the lowest sequence number in the common queue Qc (100) exceeds the BA window's maximum (64). As a result, the multi-link controller cannot allocate any packets from the common queue Qc to either the link queue Q1 or Q2.

The link queue Q1 may receive a first set of packets from the common queue Qc and buffer the first set of packets. The link queue Q2 may receive a second set of packets from the common queue Qc and buffer the second set of packets. Ideally, the MAC controller 121 may transmit the packet buffered in the link queue Q1 during the first transmission opportunity, and the MAC controller 122 may transmit the packet buffered in the link queue Q2 during the second transmission opportunity. However, If the wireless channel status of either link LK1 or LK2 deteriorates over time, packets in the corresponding link queue Q1 or Q2 may become blocked. The blockage may prevent the multi-link controller 11 from allocating the new packets to the link queues Q1 and Q2 due to BA window size constraints, reducing transmission efficiency.

To address this issue, the multi-link controller 11 may enable a link redirect mode if one of the MAC controllers 121 and 122 is granted a transmission opportunity while the other is not. In the link redirect mode, the MAC controller having the transmission opportunity may transmit the packets from both the link queue thereof and the link queue of the other MAC controller have not been granted the transmission opportunity, enabling smoother packet transmission across all link queues, while increasing overall transmission efficiency. In some embodiments, the MAC controller having the transmission opportunity may use the transmission rate of the associated link to transmit packets from either link queue. For example, if the link LK1 has a 40 MHz bandwidth and the link LK2 has an 80 MHz bandwidth, the MAC controller 121 (associated with LK1) would use the 40 MHz bandwidth to transmit packets from both the link queues Q1 and Q2, even if the packets in the link queue Q2 were originally intended for the higher-bandwidth link LK2. In some embodiments, the multi-link controller 11 may determine whether to enable the link redirect mode according to the air efficiency of the first set of packets and the second set of packets, as shown in Table 1 below:

TABLE 1

| | Ea1 > Th | Ea1 ≤ Th |
|---|---|---|
| | (efficient) | (inefficient) |
| Ea2 > Th (efficient) | N/A | enabled |
| Ea2 ≤ Th (inefficient) | enabled | N/A |

According to Table 1, if the air efficiency Ea1 of the first set of packets exceeds the threshold Th and the air efficiency Ea2 of the second set of packets also exceeds the threshold Th, transmitting either set of packets during the transmission opportunity would ensure efficient transmission. Consequently, the multi-link controller 11 may disable the link redirect mode, enabling each MAC controller having the transmission opportunity to transmit the packets from the link queue thereof. When the MAC controller 121 is granted a transmission opportunity and the MAC controller 122 is not, and if the air efficiency Ea1 of the first set of packets is less than or equal to the threshold Th and the air efficiency Ea2 of the second set of packets exceeds the threshold Th, transmitting the first set of packets would reduce efficiency, but transmitting the second set of packets would maintain efficient transmission. In such a case, the multi-link controller 11 may enable the link redirect mode, enabling the MAC controller 121, which has the transmission opportunity, to send the second set of packets from the link queue Q2 of the MAC controller 122, which is awaiting a transmission opportunity. When the MAC controller 122 is granted a transmission opportunity and the MAC controller 121 is not, and if the air efficiency Ea1 of the first set of packets exceeds the threshold Th and the air efficiency Ea2 of the second set of packets is less than or equal to the threshold Th, transmitting the second set of packets would reduce efficiency, but transmitting the first set of packets would maintain efficient transmission. In such a case, the multi-link controller 11 may enable the link redirect mode, enabling the MAC controller 122, which has the transmission opportunity, to send the second set of packets from the link queue Q1 of the MAC controller 121, which is awaiting a transmission opportunity. If both the air efficiency Ea1 of the first set of packets and the air efficiency Ea2 of the second set of packets are less than or equal to the threshold Th, transmitting either set of packets would reduce efficiency. Therefore, the multi-link controller 11 may disable the link redirect mode, enabling the MAC controller having the granted transmission opportunity to transmit packets from the link queue thereof. The method of calculating the air efficiency will be explained later. In other embodiments, the multi-link controller 11 may determine whether to enable the link redirect mode according to the quantity of packets in the first set of packets and the quantity of the second set of packets. The specific method will be discussed later.

The invention is not limited to use the multi-link controller 11 to determine whether to perform the link redirect mode. In some embodiments, the MAC controller 121 and/or 122 may also determine whether to enable the link redirect mode according to the internal configurations based on the similar approach as discussed earlier.

The invention is not limited to transmitting packets over just two links. In other embodiments, the multi-link device 1 may transmit packets over other quantities of links, and those skilled in the art could adapt the device to support the other quantities of links, in accordance with the principles of this invention.

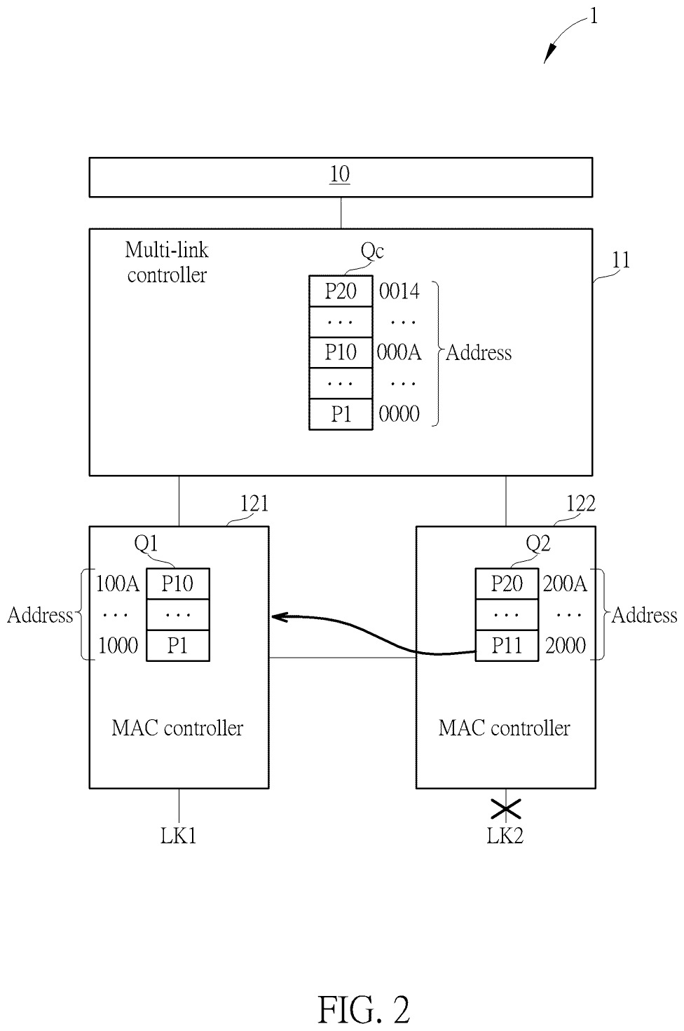

FIG. 2 is a schematic diagram of a method of operating the multi-link device 1, where the multi-link controller 11 may receive packets P1 to P20 from the upper layer 10 and buffer the packets P1 to P20 at addresses 0000 to 0014 (in hexadecimal) in the common queue Qc. The multi-link controller 11 may assign the packets P1 to P10 to the MAC controller 121 and the packets P11 to P20 to the MAC controller 122, in accordance with the BA window size. The MAC controller 122 may buffer the packets P11 to P20 at addresses 1000 to 100 A (in hexadecimal) in the link queue Q1, and the MAC controller 122 may buffer the packets P11 to P20 at addresses 2000 to 200 A (in hexadecimal) in the link queue Q2. In some embodiments, the common queue Qc, the link queue Q1 and the link queue Q2 may be implemented by a single memory. In other embodiments, the common queue Qc, the link queue Q1 and the link queue Q2 may be implemented by multiple memories.

If the link LK2 is affected by a significant noise energy and/or prolonged interference, causing a degradation in channel conditions after packets P11 to P20 have been assigned to the link queue Q2, the multi-link controller 11 may activate the link redirect mode after the MAC controller 121 is granted the first transmission opportunity, notify the MAC controller 121 to retrieve the packets P11 to P20 from the addresses 2000 to 200 A in the link queue Q2, and transmit the packets P11 to P20 to the other multi-link device via the link LK1. In another example, if the channel conditions of the link LK1 deteriorate due to noise and interference after the packets P1 to P10 have been assigned to the link queue Q1, the multi-link controller 11 may enable the link redirect mode after the MAC controller 122 is granted the second transmission opportunity, and notify the MAC controller 122 to retrieve the packets P1 to P10 from the addresses 1000 to 100 A in the link queue Q1, and transmit the packets P1 to P10 to the other multi-link device via the link LK2. The multi-link controller 11 may enable either the MAC controllers 121 or 122 to directly access the packets in the link queue of the other MAC controller without reassigning or moving the packets, thereby reducing processing time and improving transmission efficiency.

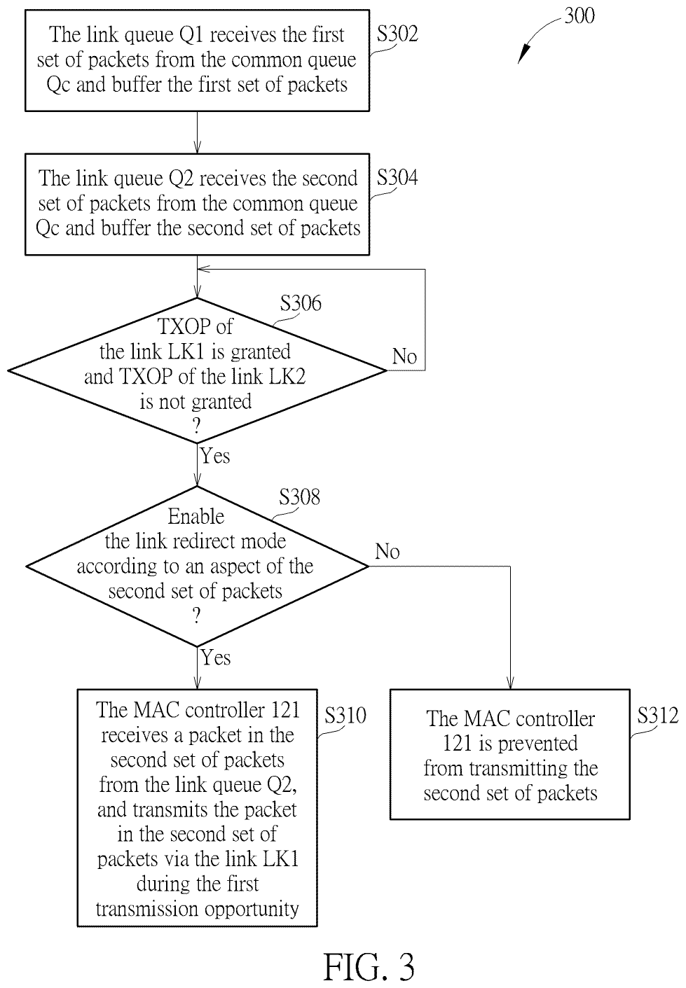

FIG. 3 is a flowchart of a method 300 of operating the multi-link device 1. The method 300 includes Steps S302 to S312 to implement the link redirect mode. Any reasonable step change or adjustment is within the scope of the disclosure. Steps S302 to S312 are detailed as follows:
Step S302: The link queue Q1 receives the first set of packets from the common queue Qc and buffer the first set of packets;
Step S304: The link queue Q2 receives the second set of packets from the common queue Qc and buffer the second set of packets;
Step S306: Determine whether the MAC controller 121 is granted the first transmission opportunity of the link LK1 and the MAC controller 122 is not granted the second transmission opportunity of the link LK2? If so, proceed to Step S308; if not, return to Step S306;
Step S308: The multi-link controller 11 determines whether to enable the link redirect mode according to an aspect of the second set of packets? If so, proceed to Step S310; if not, proceed to Step S312;
Step S310: The MAC controller 121 receives a packet in the second set of packets from the link queue Q2, and transmits the packet in the second set of packets via the link LK1 during the first transmission opportunity;
Step S312: The MAC controller 121 is prevented from transmitting the second set of packets.

In Step S306, if the MAC controller 121 is granted the transmission opportunity while the MAC controller 122 is not, the multi-link controller 11 proceeds to Step S308. If both the MAC controllers 121 and 122 are granted the transmission opportunities, neither the MAC controller 121 nor 122 is granted the transmission opportunity, or the MAC controller 122 is granted the transmission opportunity while the MAC controller 121 is not, the multi-link controller 11 returns to Step S306 to continuously check the transmission opportunities of both the MAC controllers until the condition where the MAC controller 121 is granted the transmission opportunity and the MAC controller 122 is not is met.

In Step S308, the link controller 11 may determine whether to enable link redirect mode according to an aspect of the second set of packets, the configuration of the first the link LK1 (such as the physical layer data rate of the link LK1), and/or the internal status of the overall circuit (e.g., queue status). If the MAC controller 121 is granted the first transmission opportunity of the link LK1 and the MAC controller 122 is not, the multi-link controller 11 will determine whether to enable the link redirect mode. The aspect of the second set of packets may be the air efficiency and/or the quantity of packets. In some embodiments, the multi-link controller 11 may determine the transmission time limit of the first transmission opportunity according to the access category of the first set of packets, calculate an air efficiency according to the transmission time limit of the first transmission opportunity and the transmission time for transmitting the second set of packets via the first link, and determine whether to enable the link redirect mode according to the air efficiency and a threshold. In some embodiments, the multi-link controller 11 may instruct the MAC controller 121 to analyze the second set of packets in the link queue Q2, obtaining the packet length of each packet in the second set of packets. The multi-link controller 11 may calculate the transmission time for transmitting the second set of packets via the link LK1 according to the total packet length of all packets in the second set of packets and the physical layer data rate (PHY rate) of the link LK1. Further, the multi-link controller 11 may divide the transmission time for transmitting the second set of packets by the transmission time limit of the first transmission opportunity to generate the air efficiency of the second set of packets. The physical layer data rate of the link LK1 may be the identical to or different from the physical layer data rate of the link LK2. If the air efficiency of the second set of packets exceeds the threshold, the multi-link controller 11 may enable the link redirect mode, allowing the MAC controller 121 to transmit the second set of packets via the link LK1 (Step S310). If the air efficiency of the second set of packets is less than or equal to the threshold, the multi-link controller 11 may disable the link redirect mode, allowing the MAC controller 121 to transmit the first set of packets in the link queue Q1 via the link LK1 while the second set of packets remains untransmitted (Step S312). For example, if the transmission time limit of the first transmission opportunity is 5 ms, and the transmission time for transmitting the second set of packets via the link LK1 is 4 ms, the air efficiency of the second set of packets is 0.8 (=4/5). If the threshold is 0.5, since the air efficiency (0.8) of the second set of packets exceeds the threshold (0.8>0.5), the multi-link controller 11 may enable the link redirect mode, allowing the MAC controller 121 to transmit the second set of packets via the link LK1. In some embodiments, the MAC controller 121 and/or 122 may independently determine whether to enable the link redirect mode according to the internal configurations based on the approach similar to that employed by the multi-link controller 11.

In other embodiments, the multi-link controller 11 may calculate a first air efficiency according to a transmission time limit of the first transmission opportunity and a first transmission time for transmitting the first set of packets via the first link, calculate a second air efficiency according to the transmission time limit of the first transmission opportunity and a second transmission time for transmitting the second set of packets via the first link, calculate a difference between the second air efficiency and the first air efficiency, and determine whether to enable the link redirect mode according to the difference and a threshold. In some embodiments, the MAC controller 121 may analyze the packet length of each packet in the first set of packets in the link queue Q1, calculate the first transmission time for transmitting the first set of packets via the link LK1 according to the total packet length of all packets in the first set of packets and the physical layer data rate of the link LK1, and calculate the first air efficiency according to the first transmission time and the transmission time limit of the first transmission opportunity. Next, the multi-link controller 11 may instruct the MAC controller 121 to analyze the second set of packets in the link queue Q2, calculate the second transmission time for transmitting the second set of packets via the link LK1 according to the total packet length of all packets in the second set of packets and the physical layer data rate of the link LK1, and calculate the second air efficiency according to the second transmission time and the transmission time limit of the first transmission opportunity. Following this, the multi-link controller 11 may calculate the difference between the second air efficiency and the first air efficiency. If the difference exceeds the threshold, the multi-link controller 11 may enable the link redirect mode, prompting the MAC controller 121 to transmit the second set of packets via the link LK1 (Step S310). If the difference is less than or equal to the threshold, the multi-link controller 11 may disable the link redirect mode, resulting in the MAC controller 121 transmitting the first set of packets via the link LK1 while not transmitting the second set of packets (Step S312). For example, if the transmission time limit of the first transmission opportunity is 5 ms, the first transmission time for transmitting the first set of packets via the link LK1 is Ims, and the second transmission time for transmitting the second set of packets via the link LK1 is 4 ms, then the air efficiency of the first set of packets is 0.2 (=⅕), and the air efficiency of the second set of packets is 0.8 (=⅘). The difference between the second air efficiency and the first air efficiency is 0.6 (=0.8-0.2). If the threshold is 0.5, since the difference exceeds the threshold (0.6>0.5), the multi-link controller 11 may enable the link redirect mode, allowing the MAC controller 121 to transmit the second set of packets via the link LK1.

In other embodiments, the multi-link controller 11 may calculate the difference between the quantity of packets in the second set of packets and the quantity of packets in the first set of packets, and determine whether to enable the link redirect mode according to the difference and a threshold. If the difference exceeds the threshold, the multi-link controller 11 may enable the link redirect mode, prompting the MAC controller 121 to transmit the second set of packets via the link LK1 (Step S310). If the difference is less than or equal to the threshold, the multi-link controller 11 may disable the link redirect mode, resulting in the MAC controller 121 transmitting the first set of packets via the link LK1 while not transmitting the second set of packets (Step S312). For example, if the quantity of packets in the first set of packets is 10 and the quantity of packets in the second set of packets is 128, the difference between the quantities of packets of the first and second sets of packets is 118 (=128-10). If the threshold is 100, since the difference exceeds the threshold (118>100), the multi-link controller 11 may enable the link redirect mode, allowing the MAC controller 121 to transmit the second set of packets via the link LK1.

In other embodiments, the multi-link controller 11 may directly determine whether to enable the link redirect mode according to the quantity of packets in the first set of packets and the quantity of the second set of packets. If the quantity of packets in the first set of packets is 0 and the quantity of packets in the second set of packets exceeds 0, the multi-link controller 11 may enable the link redirect mode, allowing the MAC controller 121 to transmit the second set of packets via the link LK1 (Step S310). If the quantity of packets in the first set of packets exceeds 0, the multi-link controller 11 may disable the link redirect mode, allowing the MAC controller 121 to transmit the first set of packets via the link LK1 while not transmitting the second set of packets (Step S312).

The various embodiments are merely examples and are not intended to limit the methods for determining whether to enable the link redirect mode. Those skilled in the art may apply other conditions to enable the link redirect mode in the method 300 in accordance with the principles of the invention, so as to enhance transmission efficiency.

In some embodiments, the multi-link controller 11 may independently count, over a predetermined period of time, the quantity of first direct transmission packets buffered in the link queue Q1 and transmitted via the link LK1, the quantity of first redirect transmission packets buffered in the link queue Q2 and transmitted via the link LK1, the quantity of second direct transmission packets buffered in the link queue Q2 and transmitted via the link LK2, and the quantity of second redirect transmission packets buffered in the link queue Q1 and transmitted via the link LK2. The multi-link controller 11 may further transmit the quantities of first direct transmission packets, first redirect transmission packets, second direct transmission packets, and/or second redirect transmission packets to the upper layer 10. If the quantities of first direct transmission packets, first redirect transmission packets, second direct transmission packets, and/or second redirect transmission packets show a packet forwarding trend, the upper layer 10 may further adjust the packet assignment configuration of the link queues Q1 and Q2 accordingly. For example, the initial packet assignment configuration of the link queues Q1 and Q2 may be 1:1. If the quantities of first direct transmission packets, first redirect transmission packets, second direct transmission packets, and/or second redirect transmission packets indicate that a packet forwarding trend for the link queue Q2, the upper layer 10 may adjust the packet assignment configuration of the link queues Q1 and Q2 to 2:1, 3:1, . . . . M:1, where M is a positive integer greater than 3. In other embodiments, the upper layer 10 may adjust the packet assignment configuration of the link queues Q1 and Q2 to ratios such as 5:3 and 9:4, but is not limited to these ratios.

Since the multi-link controller 11 independently tracks the quantities of first direct transmission packets, first redirect transmission packets, second direct transmission packets, and second redirect transmission packets, the statistical data for links LK1 and LK2 remain separate. This separation ensures that the data from one link does not affect the other. Consequently, the multi-link controller 11 can adjust the packet assignment configuration for the link queues Q1 and Q2 based on these independent quantities without any cross-link interference.

While in method 300, the MAC controller 121 may transmit all packets in the second set of packets via the link LK1 when the link redirect mode is enabled, the invention is not limited to this configuration. In some embodiments, the MAC controller 121 may further analyze each packet in the second set of packets in the link queue Q2 to determine if the packet must be transmitted via the link LK2. If so, the MAC controller 121 may be restricted from transmitting the packet in the second set of packets. Specifically, the MAC controller 121 may identify special packets that must be transmitted exclusively via the link LK2, such as management packets or sounding packets related to the link LK2. Only non-special packets will be transmitted via the link LK1, while the special packets will not be sent via the link LK1. In some embodiments, the packets may contain stamps that must be transmitted via the link LK2. The MAC controller 121 may identify those packets as special packets according to the stamps. The special packets may be retained in the link queue Q2 or returned to the multi-link controller 11.

While the method 300 describes a link redirect mode where the MAC controller 121 is granted the first transmission opportunity on the link LK1 and the MAC controller 122 is not, those skilled in the art could adapt the method 300 to a link redirect mode based on the principle of the invention where the MAC controller 122 is granted the first transmission opportunity on the link LK1 and the MAC controller 121 is not. When the multi-link device 1 has M links, where Mis an integer greater than 2, the multi-link device 1 may include M MAC controllers. Those skilled in the art could further modify the method 300 based on the principles of the present invention to enable the link redirect mode when one of the M links has a favored transmission status and another has a unfavored transmission status

Since the multi-link controller 11 may be implemented by hardware circuits and directly uses packet information from the MAC controllers 121 and 122 to determine whether to enable the link redirect mode, the multi-link device 1 can reduce transmission delay and improve transmission efficiency, while saving processing resources and data bandwidth.

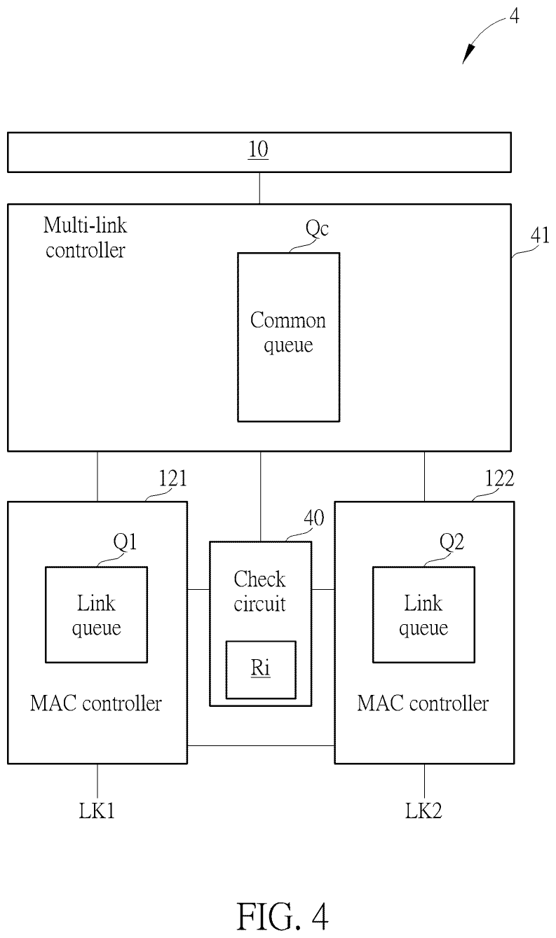

FIG. 4 is a block diagram of a multi-link device 4 according to another embodiment of the invention. The main difference between the multi-link device 4 is different from the multi-link device 1 by replacing the multi-link controller 11 with the multi-link controller 41 and introducing a check circuit 40. The main differences between the multi-link device 4 and the multi-link device 1 are discussed in the following paragraphs. The configurations and operations of the other components in the multi-link device 4 are similar to those of the multi-link device 1 and will not be described again.

The difference between the multi-link controller 41 and the multi-link controller 11 lies in that the check circuit 40 further includes an information register Ri. The information register Ri may be used to store packet information of transmitted packets. In some embodiments, the information register Ri may be disposed in other circuits of the multi-link device 1. The check circuit 40 may be coupled to the MAC controller 121 and the MAC controller 122. The check circuit 40 may verify whether a packet has been transmitted, preventing duplicate transmissions.

When the MAC controller 121 is granted the first transmission opportunity on the link LK1, and the MAC controller 122 is not granted the second transmission opportunity on the link LK2, the MAC controller 121 may obtain packet information from the second set of packets. If the link redirect mode is enabled, the MAC controller 121 may transmit the packet information to the check circuit 40, and the check circuit 40 may then query the information register Ri using the packet information to determine if any packet in the second set of packets have already been transmitted. If the information register Ri contains no matching packet information, the packet has not been transmitted. The check circuit 40 may notify the MAC controller 121 to transmit the packet to the other multi-link device. After transmitting the packet via the link LK1 to the other multi-link device, the MAC controller 121 records the packet information in the information register Ri. The packet information may include the MAC identifier (MAC ID) and/or access category of the packet. If the information register Ri contains matching packet information, the packet has already been transmitted. The check circuit 40 may notify the MAC controller 121 not to transmit the packet, avoiding duplicate transmission.

If the MAC controller 122 is later granted the second transmission opportunity on the link LK2, the MAC controller 122 may analyze the second set of packets in the link queue Q2 to obtain packet information for each packet. The MAC controller 122 may then instruct the check circuit 40 to query the information register Ri and determine whether the packets in the second set of packets have been transmitted, based on their packet information. The packet information may include the MAC identification code and/or the access category of each packet. If the information register Ri contains matching packet information, the packet has already been transmitted. The check circuit 40 may notify the MAC controller 122 not to transmit the packet, avoiding duplicate transmission. If the information register Ri does not contain matching packet information, the packet has not been transmitted. The check circuit 40 may notify the MAC controller 122 to send the packet to the other multi-link device. After transmitting the packet via the link LK2 to the other multi-link device, the MAC controller 122 may record the packet information in the information register Ri.

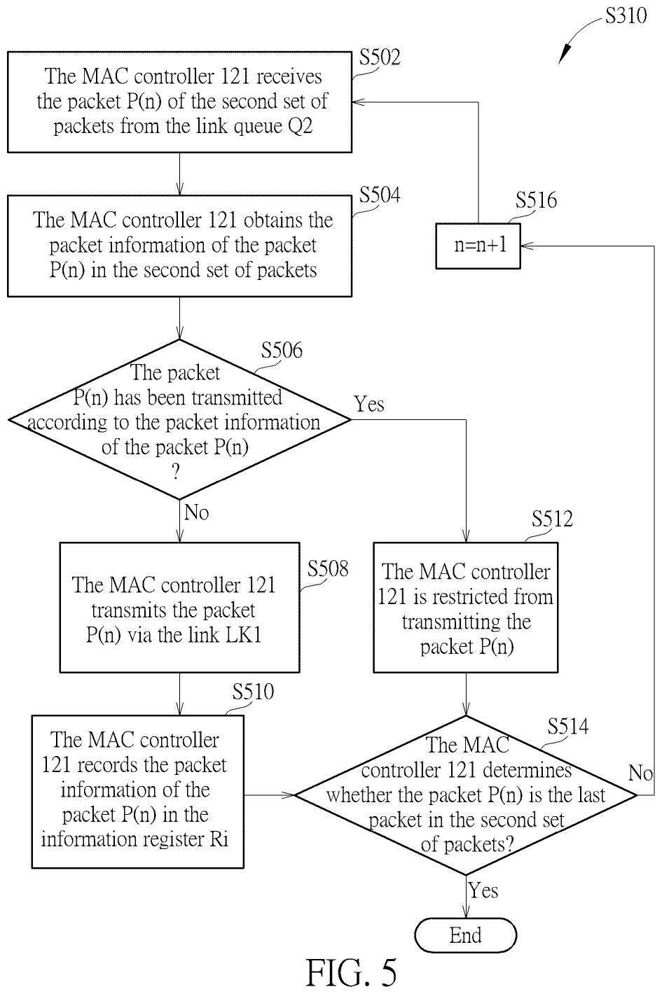

The method 300 may be utilized in the multi-link device 4. FIG. 5 is a flowchart of the link redirect step S310 in the method 300, applicable to the multi-link device 4. Step S310 includes Steps S502 to S516. Any reasonable step change or adjustment is within the scope of the disclosure. Steps S502 to S516 are detailed as follows:
Step S502: The MAC controller 121 receives the packet P (n) of the second set of packets from the link queue Q2;
Step S504: The MAC controller 121 obtains the packet information of the packet P (n) in the second set of packets;
Step S506: The check circuit 40 determines whether the packet P (n) has been transmitted according to the packet information of the packet P (n)? If so, proceed to Step S512; if not, proceed to Step S508; The MAC controller 121 transmits the packet P (n) via the link LK1; Step S508:
Step S510: The MAC controller 121 records the packet information of the packet P (n) in the information register Ri;
Step S512: The MAC controller 121 is restricted from transmitting the packet P (n);
Step S514: The MAC controller 121 determines whether the packet P (n) is the last packet in the second set of packets? If so, end Step S310; if not, proceed to Step S516;
Step S516: n=n+1; proceed to Step S502.

The second set of packets may include N packets, where N is a positive integer. The packet P (n) is one of the packets in the second set of packets, where n is a positive integer from 1 to N. At the beginning of Step S310, n=1. The MAC controller 121 receives the packet P (1) of the second set of packets from the link queue Q2 (Step S502). Since the link redirect mode is enabled, the MAC controller 121 obtains and transmits the packet information of the packet P (1) to the check circuit 40 (Step S504). The check circuit 40 queries the information register Ri using the packet information to determine whether the packet P (1) has been transmitted (Step S506). If the information register Ri contains no matching packet information, the packet P (1) has not been transmitted, and the check circuit 40 notifies the MAC controller 121 to transmit the packet P (1) to the other multi-link device via the link LK1 (Step S508). After transmitting the packet P (1), the MAC controller 121 records the packet information of the packet P (1) in the information register Ri (Step S510), and determines if the packet P (1) is the last packet in the second set of packets (Step S514). If the information register Ri contains matching packet information, the packet P (1) has been transmitted, and the check circuit 40 prevents the MAC controller 121 from transmitting the packet P (1) (Step S512). The MAC controller 121 determines if the packet P (1) is the last packet in the second set of packets (Step S514). If the packet P (1) is not the last packet in the second set of packets, the MAC controller 121 sets n to 2 (=1+1), and repeats the loop of Steps S502 to S516 for the packet P (2) in the second set of packets until the last packet P (N) in the second set of packets is reached.

Embodiments of the invention disclose a link redirect mode for multi-link operations. The link redirect mode is activated when one of the multiple links has a favored transmission status and another has an unfavored transmission status, thereby enhancing transmission efficiency without impacting processing resources or data bandwidth.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-link device comprising:
a multi-link controller comprising a common queue;
a first MAC (media access control) controller coupled to the multi-link controller and configured to perform a function of a first link, the first MAC controller comprising:
a first link queue configured to receive a first set of packets from the common queue and buffer the first set of packets; and
a second MAC controller coupled to the multi-link controller and configured to perform a function of a second link, the second MAC controller comprising:
a second link queue configured to receive a second set of packets from the common queue and buffer the second set of packets;
wherein in response to the first MAC controller being granted a first transmission opportunity of the first link, and the second MAC controller not being granted a second transmission opportunity of the second link, the multi-link controller determines whether to enable a link redirect mode according to an aspect of the second set of packets; and
in response to the link redirect mode being enabled, the first MAC controller receives a packet in the second set of packets from the second link queue, and transmits the packet in the second set of packets via the first link.

2. The multi-link device of claim 1, wherein the multi-link controller calculates an air efficiency according to a transmission time limit of the first transmission opportunity and a transmission time for transmitting the second set of packets via the first link, and determines whether to enable the link redirect mode according to the air efficiency and a threshold.

3. The multi-link device of claim 1, wherein the multi-link controller calculates a first air efficiency according to a transmission time limit of the first transmission opportunity and a first transmission time for transmitting the first set of packets via the first link, calculates a second air efficiency according to the transmission time limit of the first transmission opportunity and a second transmission time for transmitting the second set of packets via the first link, calculates a difference between the second air efficiency and the first air efficiency, and determines whether to enable the link redirect mode according to the difference and a threshold.

4. The multi-link device of claim 1, wherein the multi-link controller calculates a difference between a packet quantity of the second set of packets and a packet quantity of the first set of packets, and determines whether to enable the link redirect mode according to the difference and a threshold.

5. The multi-link device of claim 1, wherein in response to the link redirect mode being enabled, the first MAC controller further obtains packet information of the packet in the second set of packets, and records the packet information of the packet in the set packet in an information register before transmitting the packet in the second set of packets.

6. The multi-link device of claim 5, further comprising:
a check circuit coupled to the multi-link controller, the first MAC controller and the second MAC controller, configured to query the information register to determine if the packet in the second set of packets has been transmitted according to the packet information of the packet in the second set of packets, and if not, enable the first MAC controller to transmit the packet in the second set of packets via the first link.

7. The multi-link device of claim 6, wherein:
in response to the link redirect mode being enabled, the first MAC controller further obtains packet information of another packet in the second set of packets, and the check circuit queries the information register according to the packet information of the another packet in the second set of packets to determine if that packet has been transmitted, and if so, prevents the first MAC controller from transmitting the another packet in the second set of packets.

8. The multi-link device of claim 6, wherein:
the second MAC controller further obtains the packet information of the packet in the second set of packets after a second transmission opportunity of the second link is granted; and
the check circuit queries the information register to determine according to the packet information of the packet in the second set of packets if the packet in the second set of packets has been transmitted, and if so, prevents the second MAC controller from transmitting the another packet in the second set of packets.

9. The multi-link device of claim 1, wherein:
in response to the link redirect mode being enabled, the first MAC controller further analyzes another packet in the second set of packets to determine if the another packet must be transmitted via the second link, if so, preventing the MAC controller from transmitting the another packet in the second set of packets.

10. The multi-link device of claim 1, wherein the multi-link controller independently counts a quantity of first direct transmission packets buffered in the first link queue and transmitted via the first link, and a quantity of first redirect transmission packets buffered in the second link queue and transmitted via the first link, a quantity of second direct transmission packets buffered in the second link queue and transmitted via the second link, and a quantity of second redirect transmission packets buffered in the first link queue and transmitted via the second link, and transmits the quantity of first direct transmission packets, the quantity of first redirect transmission packets, the quantity of second direct transmission packets, and the quantity of second redirect transmission packets to an upper layer.

11. A method of operating a multi-link device, the multi-link device comprising a multi-link controller, a first MAC controller and a second MAC controller, the multi-link controller comprising a common queue, the first MAC controller being coupled to the multi-link controller to perform a function of a first link and comprising a first link queue, the second MAC controller being coupled to the multi-link controller to perform a function of a second link and comprising a second link queue, the method comprising:
the first link queue receiving a first set of packets from the common queue and buffering the first set of packets;
the second link queue receiving a second set of packets from the common queue and buffering the second set of packets;
in response to the first MAC controller being granted a first transmission opportunity of the first link, and the second MAC controller not being granted a second transmission opportunity of the second link, the multi-link controller determining whether to enable a link redirect mode according to an aspect of the second set of packets; and
in response to the link redirect mode being enabled, the first MAC controller receiving a packet in the second set of packets from the second link queue, and transmitting the packet in the second set of packets via the first link.

12. The method of claim 11, wherein in response to the first MAC controller being granted the first transmission opportunity of the first link, and the second MAC controller not being granted the second transmission opportunity of the second link, the multi-link controller determining whether to enable the link redirect mode according to the aspect of the second set of packets comprises:
the multi-link controller calculating an air efficiency according to a transmission time limit of the first transmission opportunity and a transmission time for transmitting the second set of packets via the first link; and
the multi-link controller determining whether to enable the link redirect mode according to the air efficiency and a threshold.

13. The method of claim 11, wherein in response to the first MAC controller being granted the first transmission opportunity of the first link, and the second MAC controller not being granted the second transmission opportunity of the second link, the multi-link controller determining whether to enable the link redirect mode according to the aspect of the second set of packets comprises:
the multi-link controller calculating a first air efficiency according to a transmission time limit of the first transmission opportunity and a first transmission time for transmitting the first set of packets via the first link;
the multi-link controller calculating a second air efficiency according to the transmission time limit of the first transmission opportunity and a second transmission time for transmitting the second set of packets via the first link;
the multi-link controller calculating a difference between the second air efficiency and the first air efficiency; and
the multi-link controller determining whether to enable the link redirect mode according to the difference and a threshold.

14. The method of claim 11, wherein in response to the first MAC controller being granted the first transmission opportunity of the first link, and the second MAC controller not being granted the second transmission opportunity of the second link, the multi-link controller determining whether to enable the link redirect mode according to the aspect of the second set of packets comprises:
the multi-link controller calculating a difference between a packet quantity of the second set of packets and a packet quantity of the first set of packets; and
the multi-link controller determining whether to enable the link redirect mode according to the difference and a threshold.

15. The method of claim 11, further comprising:
in response to the link redirect mode being enabled, the first MAC controller obtaining packet information of the packet in the second set of packets, and
the first MAC controller recording the packet information of the packet in the set packet in an information register before transmitting the packet in the second set of packets.

16. The method of claim 15, wherein:
the multi-link device further comprises a check circuit coupled to the multi-link controller, the first MAC controller and the second MAC controller;
the method further comprises:
the check circuit querying the information register to determine if the packet in the second set of packets has been transmitted according to the packet information of the packet in the second set of packets; and
if not, the first MAC controller transmitting the packet in the second set of packets via the first link.

17. The method of claim 16, further comprising:
in response to the link redirect mode being enabled, the first MAC controller obtaining packet information of another packet in the second set of packets;
the check circuit querying the information register according to the packet information of the another packet in the second set of packets to determine if that packet has been transmitted; and
if so, preventing the first MAC controller from transmitting the another packet in the second set of packets.

18. The method of claim 16, further comprising:
the second MAC controller obtaining the packet information of the packet in the second set of packets after a second transmission opportunity of the second link is granted;
the check circuit querying the information register to determine if the packet in the second set of packets has been transmitted according to the packet information of the packet in the second set of packets; and
if so, preventing the second MAC controller from transmitting the another packet in the second set of packets.

19. The method of claim 11, further comprising:
in response to the link redirect mode being enabled, the first MAC controller analyzing another packet in the second set of packets to determine if the another packet must be transmitted via the second link; and
if so, preventing the first MAC controller from transmitting the another packet in the second set of packets.

20. The method of claim 11, further comprising:
the multi-link controller independently counting a quantity of first direct transmission packets buffered in the first link queue and transmitted via the first link, and a quantity of first redirect transmission packets buffered in the second link queue and transmitted via the first link, a quantity of second direct transmission packets buffered in the second link queue and transmitted via the second link, and a quantity of second redirect transmission packets buffered in the first link queue and transmitted via the second link; and
the multi-link controller transmitting the quantity of first direct transmission packets, the quantity of first redirect transmission packets, the quantity of second direct transmission packets, and the quantity of second redirect transmission packets to an upper layer.
